(19) United States
(12) Patent Application Publication
(10) Pub. No.: US 2022/0055937 A1
(43) Pub. Date: Feb. 24, 2022

(54) METHOD AND PROCESS FOR CREATING A COMPOSITE MATERIAL

(71) Applicant: Zgrit Limited, Hamilton (NZ)

(72) Inventors: Richard Nicholas Andrew DEAN, Hamilton (NZ); Clennell Charles PULLAR, Hamilton (NZ)

(21) Appl. No.: 17/276,778

(22) PCT Filed: Sep. 16, 2019
(86) PCT No.: PCT/NZ2019/050125

§ 371 Date: Mar. 16, 2021

(30) Foreign Application Priority Data
Sep. 17, 2018 (NZ) 746369
Apr. 4, 2019 (NZ) 752385

(51) Int. Cl. C03B 19/09; C03C 8/20; C03C 1/04; A47B 96/18

(52) U.S. Cl. CPC C03B 19/09; A47B 96/18; C03C 1/04; C03C 8/20

(57) ABSTRACT

The present invention relates a molded composite material and a method and process for creating the composite material from either recycled low grade mixed glass cullet or new glass. The composite material including; crushed glass; one or more aluminium compounds selected from oxide and hydrate at combined 0.40%-0.78% weight per weight of the glass; oxides of silicon, boron, sodium, calcium and potassium at combined 1.27%-1.90% weight per weight of the glass; zirconium silicate at 0.48%-1.3% weight per weight of the glass; and optionally tin oxide at 0%-0.45% weight per weight of the glass. The composite of the present invention can be used for making tiles, bench tops, work surfaces or other similar types of building products. The use of low grade mixed glass can also help reduce the amount of used glass being dumped in landfill or used in other low value enterprises such as providing highway aggregate or landfill cover.

### TECHNICAL FIELD

The present invention relates to improvements in the creation of composite materials. The present invention is particularly relevant to the creation of composite materials from new glass or recycled mixed grade cullet.

### BACKGROUND ART

Recycled glass is generally thought of by the public as being an ideal material from a recycling perspective, with waste glass being recycled into many usable products. However the reality of used glass is that it is fast becoming a major environmental problem, with huge mountains of waste glass growing at an alarming rate and with few foreseeable uses. The main issue is in most cases where glass is to be recycled it must be first separated by:
chemical composition (i.e. glass must be separate from labels and caps and the like); and
if it is to be used for quality recycled glass or new glass, also by colour.

However, due to the ease of breaking glass products and the application of non-glass constituents to glass bottles such as labels and caps, recycled glass can become very difficult to sort by colour and also to separate from labels and caps. Thus, recycled glass cannot often be easily used to reform new glass and therefore stockpiles into the aforementioned waste mountains.

One solution has been to classify recycled glass into colours, typically clear, brown and green and to ensure all contaminants other than the glass have been removed. In some situations this is not economic, due to the size of glass fragments etc. This mixed glass also includes aluminium, paper, plastic and various other contaminants. Typically this is considered the lowest grade of glass and is typically ground up and used in a number of processes such as concrete aggregate, road aggregate or the like. However, the use of mixed glass in such processes does little to address the rapidly growing stockpiles of poor quality mixed glass reserves.

The use of low grade mixed glass in recycled or new glass products can result in a very low quality product. This is due to reactions occurring during the firing process resulting in bubbling, poor finish quality, undesirable colour traits and a brittle final product.

It would therefore be advantageous to be able to produce a quality product from low cost mixed glass, substantially regardless of the composition.

It would also be useful if there would be provided a new composite material and method of making same which could provide an alternative to marble, granite, or concrete or the like.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

It is an object of the present invention to address the foregoing problems or at least to provide the public with a useful choice.

Further aspects and advantages of the present invention will become apparent from the ensuing description which is given by way of example only.

### SUMMARY OF THE INVENTION

The present invention provides a composite material and a method and process for creating the composite material.

In one aspect the invention provides a composite material including:
crushed glass;
one or more aluminium compounds selected from oxide and hydrate at combined 0.40%-0.78% weight per weight of the glass;
oxides of silicon, boron, sodium, calcium and potassium at combined 1.27%-1.90% weight per weight of the glass;
zirconium silicate at 0.5%-1.3% weight per weight of the glass; and
optionally tin oxide at 0%-0.45% weight per weight of the glass.

The composite material may be prepared by a number of techniques. Accordingly in a further aspect the invention provides a pre-firing mix including:
crushed glass;
one or more aluminium compounds selected from oxide and hydrate at combined 0.40%-0.78% weight per weight of the glass;
oxides of silicon, boron, sodium, calcium and potassium at combined 1.27%-1.90% weight per weight of the glass;
zirconium silicate at 0.5%-1.3% weight per weight of the glass; and
   optionally tin oxide at 0%-0.45% weight per weight of the glass.

In a further aspect there is provided a method for producing an article from the pre-firing mix of the present invention including the steps of:

1) forming the pre-firing mix into a desired shape to produce a shaped pre-firing mix;
2) firing the shaped pre-firing mix so as to produce a fired mix according to a variable heating process; and
3) cooling the fired mix to provide the article from the pre-firing mix.

In a further aspect the invention provides the article produced by the process.

The composite material, pre-firing mix and/or fired mix may further include a colouring agent, such as one or more colour stains. In some embodiments the composite includes a colouring agent at greater than 0.6% weight per weight of the glass. Typically the colouring agent is present at less than 10% weight per weight of the glass, such as less than 5% weight per weight of the glass, such as less than 3% weight per weight of the glass.

Advantageously the composite material of the present invention has an attractive appearance, useful mechanical properties and can be formed in a multitude of shapes. Furthermore, wires, pipes or hollow structures may be located (such as embedded) within the shaped pre-firing mix such that they are incorporated into the structure of the composite material.

A further advantage provided by the invention is that the glass may be recycled or new glass, or a combination of recycled and new glass, although generally it is directed to the recycling of used glass and hence it is preferred to use glass in the form of mixed glass cullet.

### DETAILED DESCRIPTION OF THE INVENTION

The composite material may be in the form of a glass type state of matter being a solid which is produced from a non-solid granular/powdered mixture of components (i.e. a pre-fire mix) following a heating and cooling process.

The term ‘solid’ as used herein refers to a material which is both rigid and fixed in form such that it is not flowable. Accordingly, granules or powders, or mixtures thereof, are not considered solids.

The pre-firing mix may be a blended mixture of predominantly granular/powdered components.

In some embodiments the composite material may be subjected to one or more further processing steps including grinding, sand blasting, polishing to different levels, and printing with designs. In this respect the composite material may be formed with a multitude of different finishes.

Typically the crushed glass used will be finely crushed glass. In the context of the present invention, finely crushed glass should be understood to mean glass corresponding to a granular size up to 0.9 mm³. More specifically, the preferred range is between 0.075 and 0.3 mm³. The desired particle size distribution can be achieved through a number of different techniques, including the use of sieves. It has been found that the composite material of the invention has superior mechanical properties if the glass that is used has been sieved with a sieve (typically stainless steel) of #60 mesh.

Without wishing to be bound by theory, it is believed that the presence of large particles of glass may cause stress within the composite material.

Advantageously any material deemed too large (such as not passing through the #60 mesh) may simply be subjected to further crushing so that the material is not wasted.

The glass may be recycled or new glass, or a combination of recycled and new glass, although generally it is directed to the recycling of used glass and hence it is preferred to use glass in the form of mixed glass cullet.

Mixed glass cullet refers to glass that has not been sorted by colour and has not had impurities such as paper, plastics and metals separated from the glass. This is the lowest grade of glass cullet and is typically either dumped in landfill or used in low value enterprises such as providing highway aggregate or landfill cover.

In some embodiments the pre-firing mix is a dry mixture—being substantially free of water. The present invention does, however, contemplate the use of hydrated aluminium compounds such as those referred to variously as aluminium trihydrate (ATH), aluminium hydroxide, alumina hydrate and hydrated alumina.

In the composite material and method of the invention, one or more aluminium compounds selected from oxide and hydrate at combined 0.40%-0.78% weight per weight of the glass are used. In some embodiments the one or more aluminium compounds are used at a combined 0.50%-0.70% weight per weight of the glass. In a preferred embodiment the one or more aluminium compounds are used at 0.65%-0.68% weight per weight of the glass, such as about 0.67% weight per weight of the glass. Preferably the aluminium compounds are selected from the oxide (Al₂O₃) and alumina hydrate (Al₂(OH)₆).

For example, the composite material of the invention may be formed from a mixture of alumina hydrate (0.35%-0.70% weight per weight of the glass, preferably about 0.60% weight per weight of the glass) and aluminium oxide (0.053%-0.078% weight per weight of the glass, preferably about 0.066% weight per weight of the glass).

In the composite material and method of the invention, oxides of silicon, boron, sodium, calcium and potassium at combined 1.27%-1.90% weight per weight of the glass are used. In some embodiments silicon dioxide (SiO₂) may be used at 0.72%-1.06% weight per weight of the glass, preferably about 0.89% weight per weight of the glass. In some embodiments boron oxide (B₂O₃) may be used at 0.24%-0.35% weight per weight of the glass, preferably about 0.29% weight per weight of the glass. In some embodiments sodium oxide (Na₂O) may be used at 0.11%-0.15% weight per weight of the glass, preferably about 0.13% weight per weight of the glass. In some embodiments calcium oxide (CaO) may be used at 0.21%-0.30% weight per weight of the glass, preferably about 0.26% weight per weight of the glass. In some embodiments potassium oxide (K₂O) may be used at 0.014%-0.022% weight per weight of the glass, preferably about 0.018% weight per weight of the glass.

It will be understood that commercially available mixtures of oxides of silicon, boron, sodium, calcium and/or potassium are available, and the use of such mixtures is contemplated by the present invention.

For example, Frit 3134-2 (a high calcia borosilicate frit) consists of oxides of silicon (45.56%), boron (22.79%), sodium (10.14%), calcium (19.51%) and aluminium (2.00%), with the approximate weight percentages of the oxides as shown. In some embodiments Frit 3134-2 may be used at 0.75%-1.05% weight per weight of the glass, preferably about 0.90% weight per weight of the glass.

By way of further example, Frit KMP4131 consists of oxides of potassium (2.40%), silicon (63.81%), boron (11.77%), sodium (5.03%), calcium (10.65%) and aluminium (6.34%). In some embodiments Frit KMP4131 may be used at 0.6%-0.9% weight per weight of the glass, preferably about 0.75% weight per weight of the glass.

The inventors have found the addition of Frits to the pre-fire mix helps reduce the firing temperature required to form the composite material of the present invention.

In some embodiments zirconium silicate (ZrSiO₂) may be used at 0.5%-1.3% weight per weight of the glass, preferably about 0.70% weight per weight of the glass.

Tin oxide may be optionally used at 0%-0.45% weight per weight of the glass, preferably about 0.30% weight per weight of the glass.

It has also been discovered that the use of zirconium silicate (ZrSiO₂) and tin oxide (SnO₂) affects the mechanical and aesthetic properties of the composite material. In particular, conversely, decreasing the amount of tin oxide increases the brittleness of the composite material. Increasing the amount of zirconium silicate increases the hardness of the composite material which can lead to brittleness. Increasing the amount of tin oxide increases the softness to the composite material and reduces, or even eliminates, any brittleness provided by zirconium silicate.

Furthermore, zirconium silicate provides the composite material with a whiter form of opacity, whereas increasing the amount of tin oxide provides the composite material with a yellow-white appearance.

Increasing the amount of tin oxide provides the composite material with improved resistance to thermal shock.

Each of the above-mentioned mechanical and aesthetic properties may be modulated by the skilled addressee to obtain a composite material having the desired characteristics. For example, it has been discovered that tin oxide provides the composite material with twice the degree of opacity than the equivalent use of zirconium silicate. As such, in order to maintain opacity, for every 0.1% reduction in tin oxide content, the zirconium silicate content should be increased by 0.2% if the degree of opacity is to be maintained.

It will be understood that the chemical structure of the components of the pre-firing mix may or may not undergo modification as a result of the firing step. Nonetheless the person skilled in the art will appreciate that it is convenient to refer to the composition of the final composite material with reference to the components used to make the composite material. For example, alumina hydrate will undergo dehydration as it is heated above about 180° C. to form the oxide.

The particle size of the non-glass components of the pre-firing mix is preferably controlled. In particular, the non-glass components are preferably passed through a sieve. It has been found that the composite material of the invention has superior mechanical properties if the glass that is used has been sieved with a sieve (typically stainless steel) of #60 mesh. Without wishing to be bound by theory, it is believed that the presence of large particles of any one or more of the non-glass components may cause stress within the composite material.

Preferably the pre-firing mix is mixed until the components are substantially evenly mixed. A rotary drum mixer may be used to achieve this effect. The duration of the mixing process will be understood to be proportional to the volume of material to be prepared, therefore, the exact mixing time should not be seen to be limiting. The pre-firing mix may be mixed for anywhere from 15 to 60 minutes, for example, depending on the size of the batch.

In some embodiments, the non-glass components of the pre-firing mix are themselves thoroughly mixed before being added to the glass, or before the glass is added to the non-glass components.

In the methods of the invention, the step of forming the pre-firing mix into a desired shape to produce a shaped pre-firing mix may involve using a mold. In preferred embodiments the composite material may have the shape of tiles, benchtops, work surfaces, building products and the like.

The mold may be coated with a material to reduce, or even prevent, the pre-firing mix, the fired mix and/or the composite material from sticking to the mold during the method of the invention. The material may be a spray, such as a boron nitride spray. Advantageously the volatile components of a boron nitride spray take only seconds to dry once sprayed.

Where a mold is used in the step of forming the pre-firing mix into a desired shape, the pre-firing mix is typically compacted and/or vibrated into the mold. Where appropriate, the pre-firing mix may be levelled off in the mold, such as where a mold lid is being used.

In preferred embodiments the composite material may be formed with pipes and/or wires formed therein (such as embedded therein), the pipes and/or wires having a greater volumetric coefficient of thermal expansion than glass and a melting point higher than the maximum dwell temperature executed by the chosen variable heating process.

In especially preferred embodiments the pipes and/or wires formed therein are formed from copper.

In some preferred embodiments which include internal piping, the internal piping may be used for providing heat to, or removing heat from the composite material. In some preferred embodiments which include internal wires, the internal wires may be used for heating of the composite material.

The composite material of the invention may include any amount of crushed glass, such as at least 1% weight per weight of the composite material, such as at least 20% weight per weight of the composite material, such as at least 40% weight per weight of the composite material, such as at least 60% weight per weight of the composite material, such as at least 80% weight per weight of the composite material, such as at least 95% weight per weight of the composite material. The remainder of the composite material may include, for example: colorant; pipes; and/or wires.

For example the composite material may solely (100%) include:
a) crushed glass;
b) one or more aluminium compounds selected from oxide and hydrate at combined 0.40%-0.78% weight per weight of the glass;
c) oxides of silicon, boron, sodium, calcium and potassium at combined 1.27%-1.90% weight per weight of the glass; and
d) zirconium silicate at 0.5%-1.3% weight per weight of the glass.

In such an embodiment the crushed glass shall comprise 97.83% weight per weight of the composite material.

The composite material may include, for example, up to about 97.83% weight per weight of crushed glass. The composite material may include, for example, at least about 95.57% weight per weight of crushed glass.

Where the composite material is formed with colorant, pipes and/or wires formed therein (such as embedded therein) the remainder of the composite material may be formed from:
a) crushed glass;
b) one or more aluminium compounds selected from oxide and hydrate at combined 0.40%-0.78% weight per weight of the glass;
c) oxides of silicon, boron, sodium, calcium and potassium at combined 1.27%-1.90% weight per weight of the glass;
d) zirconium silicate at 0.5%-1.3% weight per weight of the glass; and
e) optionally tin oxide at 0%-0.45% weight per weight of the glass.

In such embodiments, it will be recognised that if the colorant, pipes and/or wires comprise, for example, 30% weight per weight of the composite material, then the remaining 70% (by way of example) weight per weight of the composite material may include:
a) crushed glass;
b) one or more aluminium compounds selected from oxide and hydrate at combined 0.40%-0.78% weight per weight of the glass;
c) oxides of silicon, boron, sodium, calcium and potassium at combined 1.27%-1.90% weight per weight of the glass;
d) zirconium silicate at 0.5%-1.3% weight per weight of the glass; and
e) optionally tin oxide at 0%-0.45% weight per weight of the glass.

The step of firing the shaped pre-firing mix so as to produce a fired mix (the firing step) may be performed by cycling the kiln through one or more temperature set points using at least one dwell time and at least one pre-defined ramp rate as part of a variable heating process.

In preferred embodiments the kiln temperature set points may include a maximum temperature of between 680-1100° C.

It should also be understood that the times, temperatures, and ramp rates specified are based upon a particular kiln and type/quantity of product and that a different variable heating process may be required to achieve the same final product composition in a different kiln or with different amounts of product. This variability between kilns is well known in the art of producing glass or clay products and the like. It will therefore be appreciated that the variable heating processes outlined herein are non-limiting examples rather than a rigidly limiting disclosure.

A method of producing a composite material according to a variable heating process including the steps of:
a) raising a kiln from an ambient temperature at a rate of approximately 20 to 100° C. per hour to a temperature of substantially 350° C.;
b) holding the kiln temperature at substantially 350° C. for substantially 20 minutes;
c) raising the kiln temperature from substantially 350° C. at a rate of approximately 20 to 140° C. per hour to a temperature of 550° C.;
d) holding the kiln temperature at substantially 550° C. for substantially 20 minutes;
e) raising the kiln temperature from substantially 550° C. at a rate of approximately 20 to 145° C. per hour to a temperature of 800° C.;
f) holding the kiln temperature at substantially 800° C. for substantially 20 minutes;
g) raising the kiln temperature from substantially 800° C. at a rate of approximately 20 to 130° C. per hour to a temperature of 895° C.;
h) holding the kiln temperature at substantially 895° C. for substantially 30 minutes;
i) allowing the kiln temperature to fall at between approximately 20° C. per hour up to full ramp from substantially 895° C. to substantially 770° C.;
j) holding the kiln temperature at substantially 770° C. for substantially 60 minutes;
k) allowing the kiln temperature to fall at between approximately 20° C. per hour up to full ramp from substantially 770° C. to substantially 675° C.;
l) holding the kiln temperature at substantially 675° C. for substantially 60 minutes;
m) allowing the kiln temperature to fall at between approximately 20° C. per hour up to full ramp from substantially 675° C. to substantially 590° C.;
n) holding the kiln temperature at substantially 590° C. for substantially 60 minutes; and
o) allowing the kiln to self cool to ambient temperature.

It will be apparent to a person skilled in the art that any number of firing sequences, dwell times and temperature set points could be used to achieve the same final product. Therefore the present invention should not be seen as being limited to any specific variable heating process.

In one preferred embodiment the preferred variable heating process includes the further optional event p) of establishing a pattern or ornamentation on the surface of the composite material.

In one further embodiment the method of producing a composite material includes the further optional inter process operation during event a) of positioning (such as embedding) one or more lengths of material, such as wires, pipes or hollow structures within the mold, the pipes or hollow structures characterised in the exhibit substantially similar properties of thermal expansion and contraction as the pre-firing mix.

In preferred embodiments the length of material may be made of copper.

Preferably the firing step takes places in an oxidation atmosphere.

Preferred embodiments of the present invention may include one or more advantages over the known prior art, including:
1. A quality product that is produced from low cost mixed grade cullet and associated impurities such as aluminium, plastic or paper. The product may advantageously be produced from un-cleaned and/or un-sorted waste glass (post-consumer and/or post-industrial waste glass);
2. The product produced by the method of the present invention is very durable compared to a product produced from the low cost mixed grade cullet;
3. The mixture has no liquid content and therefore is readily retained in the mold;
4. The final product is of a substantially uniform consistency and has a desirable strength and water resistant properties;
5. The quality of the final product is not reduced significantly by the presence of impurities in the crushed glass, such as aluminium and paper;
6. The properties of the components of the composite material, once fused, result in a product having an increased melting point over standard glass;
7. The final product is of an extremely robust nature;
8. The final product is vitrified and therefore does not need to be sealed with a glaze as is the case with many ceramics;
9. In some embodiments the process may use no water or moisture of any kind.

### BRIEF DESCRIPTION OF DRAWINGS

Further aspects of the present invention will become apparent from the following description which is given by way of example only and with reference to the accompanying drawings in which:

FIG. 1 is a graph showing ramp and dwell times used in one preferred implementation of the method of the present invention for the formation of a composite tile;

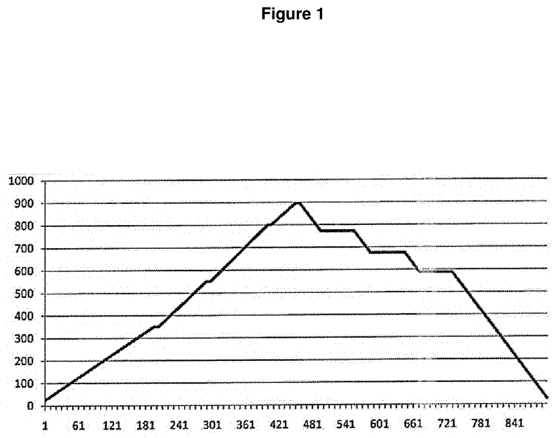

FIG. 2 is a graph showing ramp and dwell times used in a second implementation of the method of the present invention for the formation of a composite benchtop. In this embodiment the ramp rates for heating and cooling are higher than in preferred implementations where the ramp rate for heating and cooling is approximately 20-30° C. per hour;

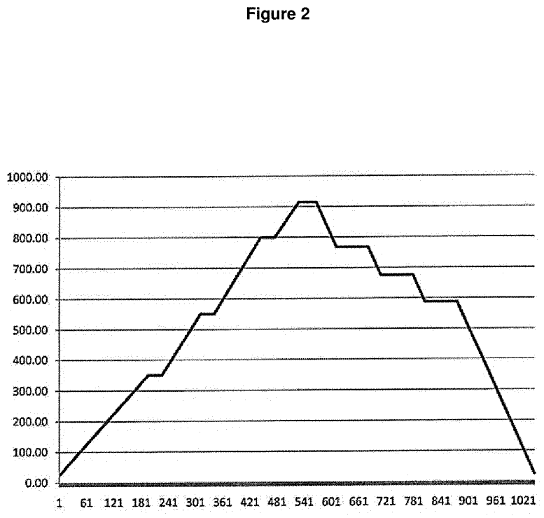

FIG. 3 is an isometric drawing showing one preferred embodiment of a mold for forming a planar block of composite material in accordance with the present invention;

FIG. 4 is an isometric drawing showing a second preferred embodiment of a mold with a lid for forming a planar block of composite material in accordance with the present invention; and

FIG. 5a-e show a pictorial representation of the various stages of operation of the mold depicted in FIG. 4.

### BEST MODES FOR CARRYING OUT THE INVENTION

The present invention will now be described by way of example.

The preparatory stage of forming a composite material includes the design and construction of a suitable mold for formation of the final shape of the composite product. The complexity of such mold construction falls outside the scope of the present invention and therefore will be excluded from the discussion herein.

### Example 1: High Quality Composite Tile

A pre-firing mix was formed by mixing together finely crushed glass (20 kg) with the following non-glass components: alumina hydrate (120 g); tin oxide (60 g); zirconium silicate (140 g); Frit 3134-2 (180 g); Frit KMP4131 (150 g); and colour stain (280 g).

The non-glass components had been passed through a #60 stainless steel sieve. The finely crushed glass was obtained from mixed glass cullet that had been passed through a #60 stainless steel sieve.

The mixture was evenly mixed together in a rotary tumble mixer before being evenly spread in a high temperature mold. The mold is made from a high temperature material and is formed in the shape of the tile to be formed and includes any surface pattern that is to be included on the tile. One or more similar molds and associated mixtures are located in a kiln at ambient room temperature.

The kiln temperature is raised from ambient temperature at a rate of 100° C. per hour to a temperature of 350° C., at which point the kiln is programmed to maintain substantially 350° C. for 20 minutes. The kiln temperature is then raised from 350° C. to 550° C. at a rate of 140° C. per hour, upon reaching 550° C. the kiln maintains temperature for 20 minutes. On completion of the hold period the kiln temperature is raised at a rate of 145° C. per hour to a temperature of 800° C., at which point the kiln maintains 800° C. for 20 minutes. The kiln temperature is then raised one final time at a rate of 130° C. per hour to a final temperature of 895° C., the kiln temperature is held at 895° C. for 7 minutes. Following the hold period, and the formation of the fired mix, the temperature of the kiln is allowed to fall in a number of stages at the kiln's natural rate of thermal loss.

It will be apparent to a person skilled in the art that the rate of cooling will vary greatly between different kilns. Furthermore, the rate of cooling of any material is proportional to the temperature differential between the material and the ambient surroundings, therefore the rate of cooling will typically be non-linear, the rate of cooling slowing greatly as the temperature becomes close to the ambient temperature. For the purposes of the present example, and simplicity of explanation, the natural rate of cooling of the kiln has been arbitrarily selected as being linear and at a rate of 200° C. per hour. The first cooling stage is from 895° C. to 770° C., the temperature is held at 770° C. for 60 minutes before it is allowed to fall to 675° C. before it is once again held for 60 minutes before being allowed to cool to 590° C. and once more held for 60 minutes. The kiln is then allowed to self cool to ambient temperature.

Once ambient temperature is reached the molds are removed from the kiln and the composite tiles can be removed in their final form.

### Example 2: Benchtop Unit

A pre-firing mix was formed by mixing together finely crushed glass (20 kg) with the following non-glass components: alumina hydrate (120 g); tin oxide (60 g); zirconium silicate (140 g); Frit 3134-2 (180 g); Frit KMP4131 (150 g); and colour stain (280 g).

The non-glass components had been passed through a #60 stainless steel sieve. The finely crushed glass was obtained from mixed glass cullet that had been passed through a #60 stainless steel sieve.

The mixture was evenly mixed together in a rotary tumble mixer before being evenly spread in a high temperature mold. The mold is made from a high temperature material and is formed in the size and shape of the benchtop to be formed and includes any surface pattern that is to be included on the benchtop. For example the benchtop is formed as a substantially homogeneous planar block corresponding to the desired shape and thickness properties of the final product. One or more similar molds and associated mixtures may be located in a kiln at ambient room temperature.

While thinner materials, such as composite tiles, can be heated and cooled at faster rates (such as 145° C. per hour), thicker materials such as planar blocks (exemplified by a benchtop unit) should preferably be heated and cooled at slower rates. Preferably these slower rates provide a temperature change of approximately 20-30° C. per hour. These slower rates allow the increased volume of glass to heat up more uniformly.

The kiln temperature is raised from ambient temperature at a rate of approximately 20-30° C. per hour to a temperature of 350° C., at which point the kiln is programmed to maintain substantially 350° C. for 30 minutes. The kiln temperature is then raised from 350° C. to 550° C. at a rate of approximately 20-30° C. per hour, upon reaching 550° C. the kiln maintains temperature for 30 minutes. On completion of the hold period the kiln temperature is raised at a rate of approximately 20-30° C. per hour to a temperature of 800° C., at which point the kiln maintains 800° C. for 30 minutes. The kiln temperature is then raised one final time at a rate of approximately 20-30° C. per hour to a final temperature of 925° C., the kiln temperature is held at 925° C. for 30 minutes. Following the hold period, and the formation of the fired mix, the temperature of the kiln is allowed to fall in a number of stages at the kiln's natural rate of thermal loss, and/or preferably at a cooling rate of approximately 20-30° C. per hour.

It will be apparent to a person skilled in the art that the kiln's natural rate of cooling will vary greatly between different kilns. Furthermore, the rate of cooling of any material is proportional to the temperature differential between the material and the ambient surroundings, therefore the rate of cooling will typically be non-linear, the rate of cooling slowing greatly as the temperature becomes close to the ambient temperature. For the purposes of the present example, and simplicity of explanation, in one embodiment the natural rate of cooling of the kiln has been arbitrarily selected as being linear and at a rate of 200° C. per hour. In one preferred embodiment, the cooling rate of the kiln is controlled to a rate of approximately 20-30° C. per hour.

The first cooling stage is from 925° C. to 770° C., the temperature is held at 770° C. for 60 minutes before it is allowed to fall to 675° C. before it is once again held for 60 minutes before being allowed to cool to 590° C. and once more held for 60 minutes. The kiln is then allowed to self cool to ambient temperature.

Once ambient temperature is reached the molds are removed from the kiln and the composite planar block can be removed and located in a further mold. The further mold (not shown) comprises a support upon which any area of the planar block which is intended to be flat is supported and a basin structure which is forms a void beneath at least a portion of the composite planar block.

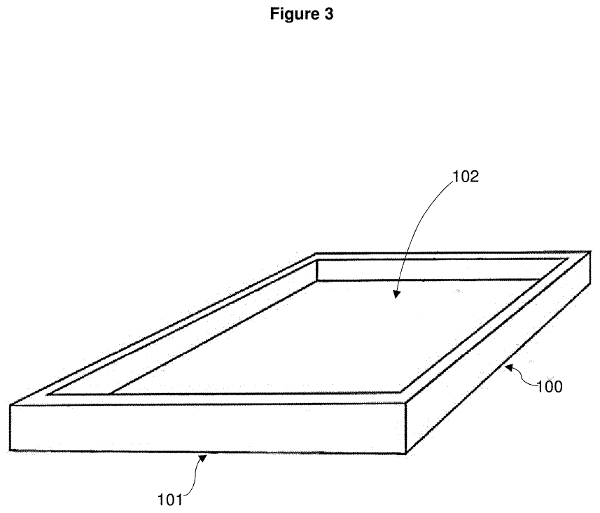

FIG. 3 shows one preferred embodiment of a mold for producing tiles, as generally indicated by arrow 100. The mold comprises a rectangular plate 101 which has a recessed central portion 102. The central portion is larger in size than the size of the tile that is to be produced. The reason for this is that as the pre-firing mix fuses into the composite material the volume of the product typically shrinks, which can result in an irregular shape and therefore sufficient excess is required so that the edges of final product can be ground square.

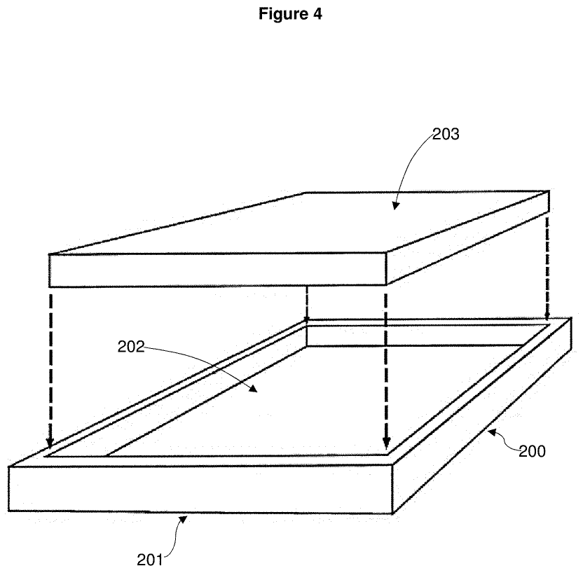

FIG. 4 shows a further preferred embodiment of a mold for producing tiles, as generally indicated by arrow 200. The mold of FIG. 4 includes a rectangular plate 201 which has a recessed central portion 202, the mold also includes a lid portion 203 which fittingly engages with the central portion 202. As the pre-firing mix fuses into the composite material the volume of the product typically shrinks. Advantageously the weight of the lid portion 203 presses down on the mixture such that the mixture conforms to the shape of the recessed central portion 202. By using a lid portion 203 the tile produced requires no further finishing in the form of grinding the edges.

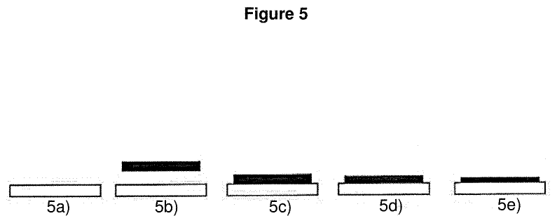

The process of the lid portion 203 maintaining the conformance of the composite product to the recessed central portion 202 by maintaining downward pressure of the mixture is illustrated in FIGS. 5a-5e, whereby the lid portion is shown moving further into the recessed central portion 202 as the composite mixture fuses and reduces in volume.

Aspects of the present invention have been described by way of example only and it should be appreciated that modifications and additions may be made thereto without departing from the scope thereof.

1. A molded composite material, comprising:
a) crushed glass;
b) one or more aluminium compounds selected from oxide and hydrate at combined 0.40%-0.78% weight per weight of the glass;
c) oxides of silicon, boron, sodium, calcium and potassium aluminium at combined 1.27%-1.90% weight per weight of the glass; and
d) zirconium silicate at 0.5%-1.3% weight per weight of the glass.

2. The molded composite material as claimed in claim 1, wherein the molded composite material is in the form of a tile.

3. The molded composite material as claimed in claim 2, wherein the molded composite material comprises:
crushed glass (20 kg);
alumina hydrate (120 g);
tin oxide (60 g);
zirconium silicate (140 g);
Frit 3134-2 (180 g);
Frit KMP4131 (150 g); and
color stain (280 g).

4. A pre-firing mix for the molded composite material as claimed in claim 2, which comprises:
crushed glass (20 kg);
alumina hydrate (120 g);
tin oxide (60 g);
zirconium silicate (140 g);
Frit 3134-2 (180 g); and
Frit KMP4131 (150 g);
color stain (280 g).

5. The molded composite material as claimed in claim 1, wherein the molded composite material is in the form of a bench top.

6. The molded composite material as claimed in claim 5, wherein the molded composite material comprises:
crushed glass (20 kg);
alumina hydrate (120 g);
tin oxide (60 g);
zirconium silicate (140 g);
Frit 3134-2 (180 g);
Frit KMP4131 (150 g); and
color stain (280 g).

7. A pre-firing mix for the molded composite material as claimed in claim 5, which comprises:
crushed glass (20 kg);
alumina hydrate (120 g);
tin oxide (60 g);
zirconium silicate (140 g);
Frit 3134-2 (180 g);
Frit KMP4131 (150 g); and
color stain (280 g).

8. A pre-firing mix for a molded composite material comprising:
a) crushed glass;
b) one or more aluminium compounds selected from oxide and hydrate at combined 0.40%-0.78% weight per weight of the glass;
c) oxides of silicon, boron, sodium, calcium and potassium at combined 1.27%-1.90% weight per weight of the glass; and
d) zirconium silicate at 0.5%-1.3% weight per weight of the glass;

9. A molded composite material, comprising:
a) crushed cullet glass;
b) one or more aluminium compounds selected from oxide and hydrate at combined 0.40%-0.78% weight per weight of the glass;
c) oxides of silicon, boron, sodium, calcium and potassium aluminium at combined 1.27%-1.90% weight per weight of the glass; and
d) zirconium silicate at 0.5%-1.3% weight per weight of the glass.

10. A molded composite material, comprising:
a) crushed glass;
b) one or more aluminium compounds selected from oxide and hydrate at combined 0.40%-0.78% weight per weight of the glass;
c) oxides of silicon, boron, sodium, calcium and potassium aluminium at combined 1.27%-1.90% weight per weight of the glass; and
d) zirconium silicate at 0.5%-1.3% weight per weight of the glass,
wherein the composite comprises no liquid content.

11. A pre-firing mix for the molded composite material as claimed in claim 3, which comprises:
crushed glass (20 kg);
alumina hydrate (120 g);
tin oxide (60 g);
zirconium silicate (140 g);
Frit 3134-2 (180 g);
Frit KMP4131 (150 g); and
color stain (280 g).

12. A pre-firing mix for the molded composite material as claimed in claim 6, which comprises:
crushed glass (20 kg);
alumina hydrate (120 g);
tin oxide (60 g);
zirconium silicate (140 g);
Frit 3134-2 (180 g);
Frit KMP4131 (150 g); and
color stain (280 g).

13. The molded composite material of claim 1, further comprising tin oxide at up to 0.45% weight per weight of the glass.

14. The pre-firing mix for a molded composite material of claim 8, further comprising tin oxide at up to 0.45% weight per weight of the glass.

15. The molded composite material of claim 9, further comprising tin oxide at up to 0.45% weight per weight of the glass.

16. The molded composite material of claim 10, further comprising tin oxide at up to 0.45% weight per weight of the glass.
